(19) United States
(12) Patent Application Publication
(10) Pub. No.: US 2019/0307293 A1
(43) Pub. Date: Oct. 10, 2019

(54) Wire-Stick With A Ring For Easy Removal Of Grilled Meat And Vegetables Kebabs

(71) Applicant: Samir KALIC, Novi Sad (RS)

(72) Inventor: Samir KALIC, Novi Sad (RS)

(21) Appl. No.: 16/469,142

(22) PCT Filed: Dec. 12, 2017
(86) PCT No.: PCT/RS2017/000015

§ 371 Date: Jun. 12, 2019

(30) Foreign Application Priority Data
Dec. 12, 2016 (RS) P-2016/1106

(51) Int. Cl. A47J 43/18; A47J 37/07; A47J 37/04

(52) U.S. Cl. CPC A47J 43/18; A47J 37/049; A47J 37/041; A47J 37/0786

(57) ABSTRACT

The invention refers to the wire-stick with ring for easy removal grilled meat and vegetables kebabs which consists of a handgrip (2) for holding with a twisted wire (3) and a ring (4). The twisted wire (3) with the handgrip (2), is made of one piece of wire where the handgrip (2) is formed by minimum one twist and circular wrapping in the middle of the wire (3), whereby the wire (3) is of circular cross section, whereas the prongs-ends of the wire (3) are mutually spirally twisted and end in a sharp tip. The ring (4) consists of a cylindrical capsule (5) and a circular plate (6), mutually tightly bound in the axis of symmetry of the ring (4) through the narrowed part (7), whereby the narrowed part (7) is in its cross section of rectangular shape with rounded shorter sides. The wire (3) is squeezed through the opening (8) in the ring (4), whereby the capsule (5) is positioned next to the handgrip (2) and the circular plate 6) is positioned from the bottom side facing the top of the wire (3). The application contains one variant of performance.

### TECHNICAL FIELD

The object of the invention, generally speaking, belongs to the area of everyday life necessities, i.e. to the area of articles for personal and home use, more specifically kitchen equipment.

According to the International classification of patents (MKP¹⁵) the object of the invention is marked and classified with basic classification symbols: A 47 J 37/07 referring to baking in the oven, frying, barbecue grilling and for outdoor roasting appliances—barbecues, A 47 J 43/18 referring to devices for clamping or holding poultry, game or other meat or vegetables while cooking or cutting and grilling on barbecue and A 47 J 43/28 referring to various equipment for food preparation or clamping and other kitchen equipment, e.g. kitchen spatulas, clamps, forks and similar objects for keeping food.

### TECHNICAL PROBLEM

The technical problem to be resolved through the present invention consists of the following: how to achieve a constructive solution for a twisted wire-skewer with a ring on which meat or vegetable would easily be placed for grilling and easily removed without residue, whereby keeping the skewer easy for production and practical for use, versatile and economical, with aesthetically attractive appearance and durable.

### TECHNICAL STATE

Grilled meat and barbecuing are traditional rituals unimaginable without various kinds of meat, vegetables and ways of preparation. For barbecue preparation specific equipment is needed, i.e.

unavoidable set of barbecue equipment. It consists of barbecue blower, meat fork, clamps and spatula. The basic preparation method of barbecue is placing meat or vegetables on a heated grill plate. Another method of preparing barbecue is so called skewers, which means skewing chosen pieces of meat side by side or alternately skewing pieces of meat, bacon and vegetables, which requires suitable skewers. To the present day skewers have been prepared in two basic ways: a) with pointed wooden sticks of the size of a pencil, which were disposed of after a single use and b) with stainless steel wires-skewers. Known metal wires-skewers are flat, smooth, with a pointed tip on one end and a round finger hole or a wooden handle on the other end for easy holding and turning on the barbecue.

Browsing both domestic and foreign patent/non-patent literature, the author of the invention has not found a single document that shows a solution or means by which the specified problem of grilling meat and vegetables would be solved.

The above described existing solutions, however, have a number of disadvantages apart from the fact that they are unattractive; the main problem being is that the user has difficulty in removing the content of the skewer easily. Thus, wooden sticks get more or less burnt and the meat grilled on them sticks to the wood. The removal of the content off the wooden stick is joined with effort and problematic bouncing or tearing of meat. This problem is usually dealt with by covering skewers with another plate and pressing to pull out the stick. Metal wires present a slightly better solution as they enable easier removal of the content. However, the problem here is that the meat also sticks to the wire, making maintaining hygiene difficult and after several uses unnecessary; as they are thrown away.

### PRESENTATION OF THE ESSENCE OF THE INVENTION

The invention refers to the wire-stick with ring for easy removal grilled meat and vegetables kebabs which consists of a handgrip for holding with a twisted wire and a ring. The twisted wire with the handgrip, according to the basic presentation is made of one piece of wire where the handgrip is formed by minimum one twist and circular wrapping in the middle of the wire, whereby the wire is of circular cross section, whereas the prongs-ends of the wire are mutually spirally twisted and end in a sharp tip. The ring consists of a cylindrical capsule and a circular plate, mutually tightly bound in the axis of symmetry of the ring through the narrowed part, whereby the narrowed part is in its cross section of rectangular shape with rounded shorter sides. The wire is squeezed through the opening in the ring, whereby the capsule of the ring is positioned next to the handgrip and the circular plate is positioned from the bottom side facing the top of the wire. According to the presentation variant, spirally twisted wire with the handgrip on its one end is formed by circular twisting of one end of the wire whereas the end of the wire is freely twisted inside the handgrip. The wire in this presentation variant is of rectangular cross section, whole-length spirally twisted and on the free end has a sharp tip.

The main aim of this invention is to enable such a solution, a wire-skewer with a ring for holding, onto which pieces of meat or vegetables could be easily placed-skewered and removed, whereby the wire would provide easy skewering, placing and removal of meat/vegetables, would be easy to produce, multiple usable and economical, visually appealing and durable. Another novelty of this solution is that the twisted wire and ring are produced from inox material, with the advantage that the ring is produced so that it can be used with all wires, be they twisted or flat band tin. This way the ring is universal irrespectively of the measure or shape of wire thread.

Twisted wire with a ring, following this invention, has several advantages of which some most important are stated:
simple construction with application of existing materials absolutely safe in human nutrition
easy skewering, placing and removal of meat/vegetables
low production cost
simple maintenance
multiple usable and economical
visually appealing and durable dr

### SHORT DESCRIPTION OF PICTURE DRAFTS

For easier understanding of the invention, as well as presenting how it can be utilised in practice, the applicant is referring to the given draft in which:

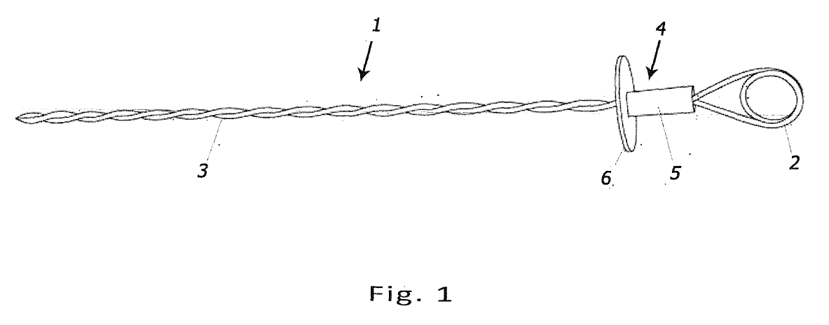

FIG. 1 shows the appearance of the wire-skewer with a ring for easy removal of grilled meat or, vegetables, according to the invention, in axonometry,

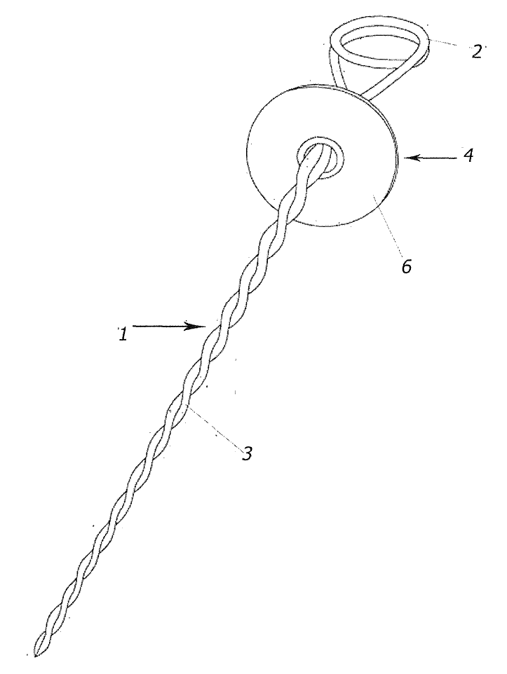

FIG. 2 shows the appearance of the wire-skewer with a ring from picture 1 in the bottom view and in axonometry,

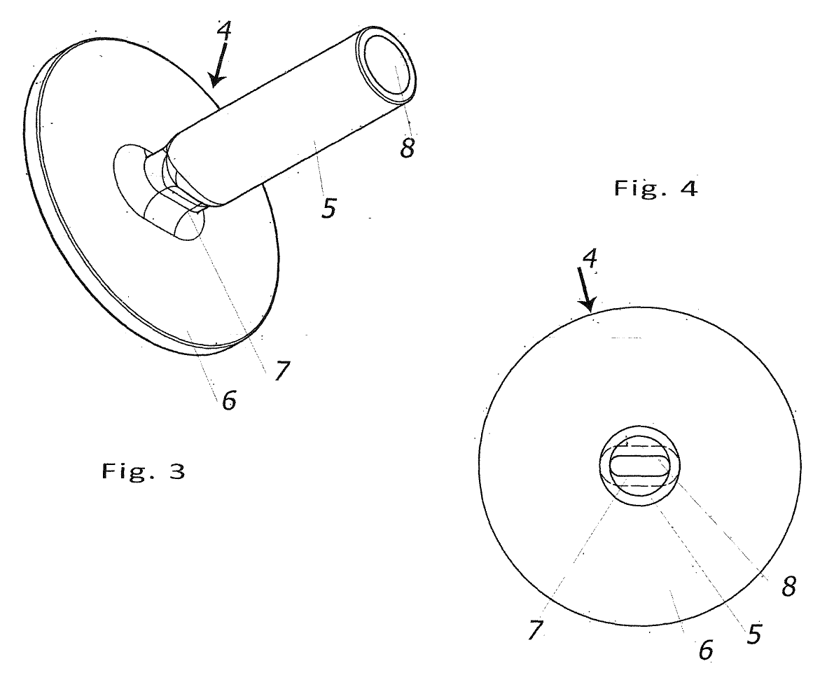

FIG. 3 shows the appearance of the ring from picture 1 in larger proportion and in axonometry,

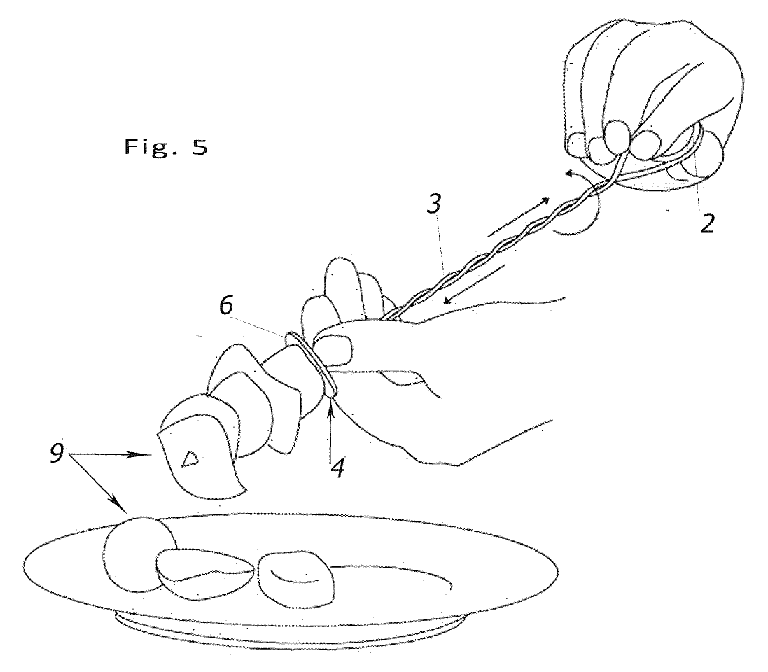

FIG. 4 shows the appearance of the ring from picture 3 in the side view of the cylindrical capsule,

FIG. 5 shows schematic view of the twisted wire with a ring from picture 1 in function with the skewer content, in axonometry,

### DETAILED DESCRIPTION OF THE INVENTION

The twisted wire 3 with a handgrip 2 in this example of performance is produced of one piece of wire so that the handgrip 2 is formed by twisting in the middle of one piece of wire of circular cross section; i.e. by minimum one circular wire wrapping 3, whereas the prongs-ends of the mentioned wire are mutually spirally twisted, resulting in a twisted wire 3 with a sharp tip, Pictures 1 and 2. The wire 3 is squeezed through the opening 8 in the ring 4 whereby the capsule 5 is placed next to the handgrip 2 and the circular plate 6 is with its bottom side turned towards the wire tip 3. The ring 4, Pictures 3 and 4, consists of a cylindrical capsule 5 and circular plates 6 which are not mutually tightly bound in the axis of symmetry of the ring 4 through a narrowed part 7. Part 7, with which the capsule 5 is fixed with the plate 6, is in the cross section rectangular-shaped with rounded shorter sides; so the opening 8 in part 7 is also of the same shape, Picture 4.

This constructed ring 4 with rectangular opening 8 in part 7 has its function shown in Picture 5. Namely, with one hand the handgrip 2 of the wire is held while with the other hand the capsule 6 of the ring 4 is held. By turning the twisted wire 3 with the handgrip 2 inside the opening 8 part 7 of the ring 4,

the wire is turning and pieces of content 9 of the skewer are released off the wire and with additional pulling-pushing of the ring 4 along the wire 3 towards the tip, easy moving of the content 9 along the wire and removal of it is achieved. Thereby the wire 3 remains clean free of content residue 9 and ready for the next application.

The way of functioning of the twisted wire with a ring for easy removal of pieces of grilled meat or vegetables off the skewer wire is simple, according to the invention, and obviously follows from the above description and draft and therefore it is not necessary to describe further in detail. However, it ought to be emphasised that the twisted wire 3 and ring 4 are produced according to the invention from inox material, with the advantage that the ring is produced so that it can be used with all wires: be they twisted or of flat band tin. This way the ring is universal irrespectively of the measure or shape of wire thread.

### INDUSTRIAL AND OTHER APPLICATION OF THE INVENTION

The application of the invention clearly follows from the previous text, i.e. for industrial use of the invention no special knowledge, guidance or experience is needed to utilize the invention successfully. The only necessary and sufficient requirement is the knowledge concerning the given field owned by an average specialist for successful application of the invention in question based on the given description. All structural and functional features have successfully been tested on the prototype by the inventor.

Furthermore, any possible structural improvements or changes concerning the presented twisted wire with a ring for easy removal of grilled meat or vegetables off the skewer wire aiming at its functional improvements are considered to be covered by this application.

1. The invention refers to the wire-stick with ring for easy removal grilled meat, and vegetables kebabs is specified by the fact that it consists of a handgrip (2, 11) for holding with a twisted wire (3, 13) and a ring (4, 14), that the twisted wire (3) with the handgrip (2) is produced from one piece of wire where the handgrip (2) is formed by minimum one twist and circular wrapping in the middle of the wire (3), whereby the wire (3) is of circular cross section and the prongs-ends of the wire (3) are mutually spirally twisted and end in a sharp tip, that the ring (4, 14) consists of a cylindrical capsule (5, 15) and a circular plate (6, 16), mutually tightly bound in the axis of symmetry of the ring (4, 14) through the narrowed part (7), whereby the narrowed part (7) is in its cross section in rectangular shape with rounded shorter sides and that the wire (3, 13) is squeezed through the opening (8) in the ring, (4, 14), whereby the capsule (5, 15) is positioned next to the handgrip (2, 11) and the circular plate (6, 16) is positioned from the bottom side facing the top of the wire (3, 13).
